(19) United States
(12) Patent Application Publication
(10) Pub. No.: US 2026/0128549 A1
(43) Pub. Date: May 7, 2026

(54) WATERPROOF CONNECTOR

(71) Applicant: KINSUN INDUSTRIES INC., Taoyuan City (TW)

(72) Inventors: Ching-Neng KAN, Taoyuan City (TW); Yihung CHANG, Taoyuan City (TW); Li-Chin YANG, Taoyuan City (TW)

(21) Appl. No.: 19/346,968

(22) Filed: Oct. 1, 2025

(30) Foreign Application Priority Data
Nov. 6, 2024 (TW) 113212098

(51) Int. Cl. H01R 13/52; H01R 4/2425; H01R 13/02; H01R 13/04; H01R 13/502; H01R 13/648

(52) U.S. Cl. CPC H01R 13/5202; H01R 4/2425; H01R 13/025; H01R 13/04; H01R 13/502; H01R 13/648

(57) ABSTRACT

A waterproof connector is provided, wherein the waterproof connector includes: a housing including a first opening, an internal space and a second opening; an electrical connection assembly received in the internal space, including a first base including at least one channel, a second base including at least one positioning portion, and at least one conductive terminal configured to be assembled with the at least one conductive wire, the first base being closer to the first opening than the second base, the at least one conductive terminal including a conductive pin portion passing through the at least one channel, and a fork portion inserted in the at least one positioning portion; and a waterproof assembly assembled to the housing so that the internal space is blocked from communicating with an outside via the second opening.

### BACKGROUND OF THE INVENTION

### Field of the Invention

The present invention relates to a connector, particularly to a waterproof connector.

### Description of the Prior Art

In addition to waterproofing, a waterproof connector should further offer dustproofing, corrosion resistance, high-temperature resistance, and good structural strength to ensure that a cable can be mated stably in harsh environments.

In conventional electrical connection methods, a conductive terminal is connected to a conductive wire by soldering, or by soldering to a circuit board for interconnection. Therefore, after the conductive terminal and the conductive wire are connected, in order to ensure that the soldered joint between the two will not break or separate during long-term use, potting is usually used to fill an internal space so that the internal space is sealed to block external liquid from entering.

However, with the above approach, when maintenance or replacement is required, the entire connection device must be destroyed and replaced, which not only increases cost but is also inconvenient for rapid assembly.

The present invention is, therefore, arisen to obviate or at least mitigate the above-mentioned disadvantages.

### SUMMARY OF THE INVENTION

The main object of the present invention is to provide a waterproof connector in which a conductive terminal can be quickly and stably electrically connected to a conductive wire, and in which waterproofing is achieved through precise assembly cooperation among components, thereby saving cost.

To achieve the above and other objects, a waterproof connector is provided, wherein the waterproof connector includes: a housing including a first opening, an internal space and a second opening in communication with one another, the second opening being configured to allow a cable to pass and extend into the internal space, the cable including at least one conductive wire; an electrical connection assembly received in the internal space, including a first base, a second base and at least one conductive terminal, the first base being closer to the first opening than the second base, the first base including at least one channel, the second base including at least one positioning portion, the at least one positioning portion being configured to be assembled with the at least one conductive wire, the at least one conductive terminal including a conductive pin portion and a fork portion, the fork portion of the at least one conductive terminal being inserted in the at least one positioning portion and configured to pierce the at least one conductive wire to form an electrical connection, the pin portion of the at least one conductive terminal passing through the at least one channel; and a waterproof assembly assembled to the housing so that the internal space is blocked from communicating with an outside via the second opening.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of an exemplary embodiment of the present invention;

FIG. 2 is an exploded view of an exemplary embodiment of the present invention;

FIG. 3 is a perspective view of an exemplary embodiment of the present invention with a housing removed;

FIG. 4 is an exploded view of a conductive terminal and a second base of FIG. 3;

FIG. 5 is a perspective view of a conductive terminal of an exemplary embodiment of the present invention; and

FIGS. 6 and 7 are cross-sectional views illustrating movement of a control member relative to a housing in an exemplary embodiment of the present invention.

### DETAILED DESCRIPTION OF THE PREFERRED EMBODIMENTS

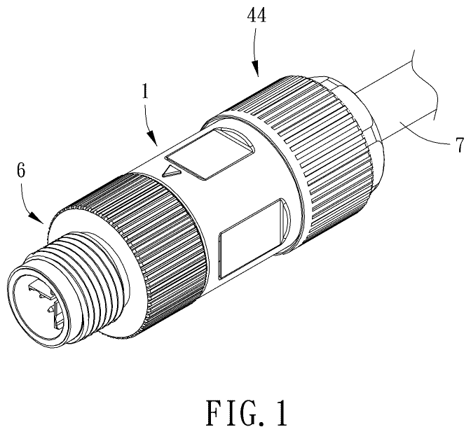

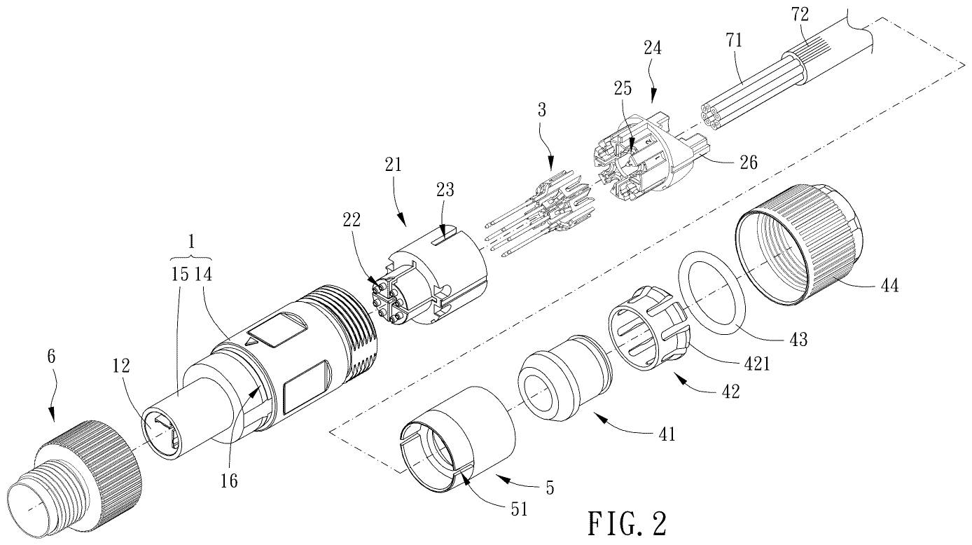

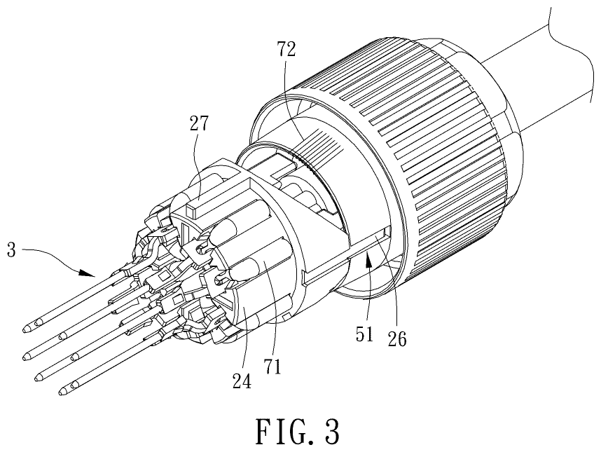

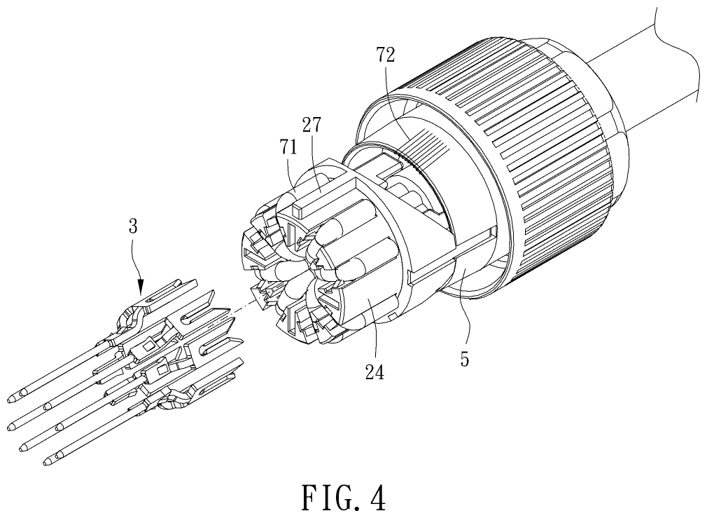

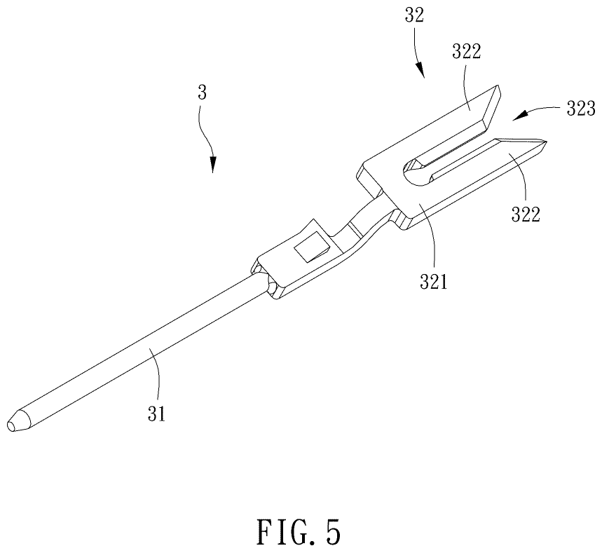

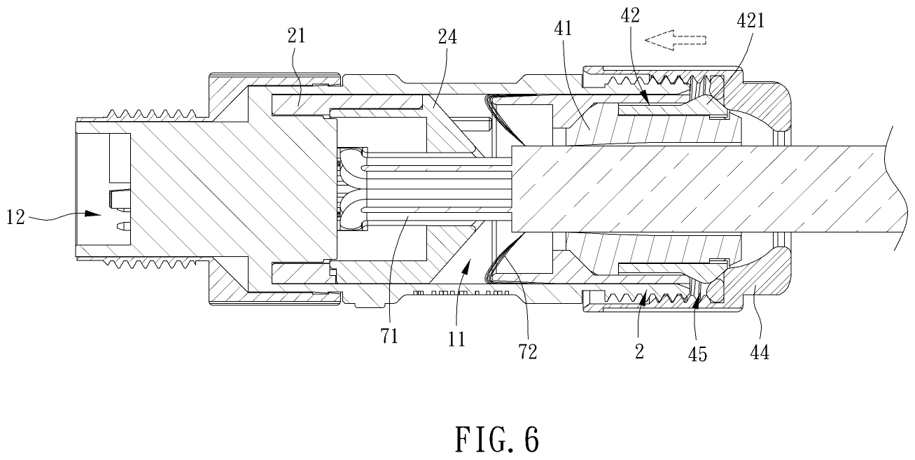

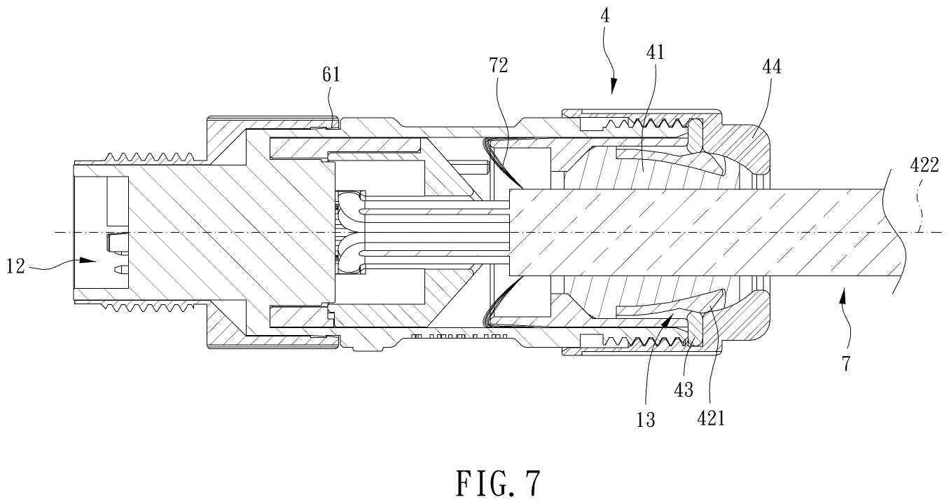

Please refer to FIGS. 1 to 7 for an exemplary embodiment of the present invention. A waterproof connector of the present invention includes a housing 1, an electrical connection assembly 2, and a waterproof assembly 4.

The housing 1 includes a first opening 12, an internal space 11 and a second opening 13 in communication with one another. The first opening 12 is configured to allow a connector of a device to be mated to be inserted. The second opening 13 is configured to allow a cable 7 to pass and extend into the internal space 11. The cable 7 includes at least one conductive wire 71.

Specifically, the waterproof connector further includes a connector 6. The housing 1 further includes a main body 14 and a pivot portion 15. The pivot portion 15 protrudes from the main body 14. The main body 14 and the pivot portion 15 define the internal space 11. The main body 14 includes the second opening 13, and the pivot portion 15 includes the first opening 12. The connector 6 is rotatably sleeved on the pivot portion 15, and the connector 6 is configured to be connected to the device to be mated. One of the connector 6 and the pivot portion 15 includes an annular groove 16, and the other of the connector 6 and the pivot portion 15 includes a projection 61. The projection 61 is movably engaged within the annular groove 16, thereby allowing the connector 6 to rotate freely relative to the pivot portion 15.

The electrical connection assembly 2 is received in the internal space 11 and includes a first base 21, a second base 24 and at least one conductive terminal 3. The first base 21 is closer to the first opening 12 than the second base 24. The first base 21 includes at least one channel 22. The second base 24 includes at least one positioning portion 25. The at least one positioning portion 25 is configured to be assembled with the at least one conductive wire 71. The at least one conductive terminal 3 includes a conductive pin portion 31 and a fork portion 32. The fork portion 32 of the at least one conductive terminal 3 is inserted in the at least one positioning portion 25 and is configured to pierce the at least one conductive wire 71 to form an electrical connection. The pin portion 31 of the at least one conductive terminal 3 passes through the at least one channel 22 to approach the first opening 12 so as to be configured to mate with the device to be assembled.

Preferably, the first base 21 and the second base 24 are both made of insulating materials to prevent electrical leakage.

Preferably, the pin portion 31 and the fork portion 32 are integrally formed of one piece, which reduces assembly steps, provides good structural continuity, and offers excellent stability in use. In this embodiment, the fork portion 32 includes a base portion 321 and two piercing members 322 which are spaced apart and protrude from the base portion 321 to pierce the conductive wire 71. Free ends of the two piercing members 322 define a receiving hole 323 which gradually widens in a direction away from the base portion 321. The receiving hole 323 is configured to receive a portion of the conductive wire 71 so that the two piercing members 322 can firmly clamp the conductive wire 71 to reliably maintain the connection that is not easily separated or detached.

The waterproof assembly 4 is assembled to the housing 1 so that the internal space 11 is blocked from communicating with an outside via the second opening 13. External liquid is thereby prevented from entering the internal space 11 via the second opening 13, ensuring sufficient safety for use of the waterproof connector in environments exposed to the outside or liquids, without the user needing to worry about electrical leakage.

The waterproof connector preferably further includes a conductive grounding element 5. The grounding element 5 is disposed in the internal space 11 and is configured to be electrically connected to a grounding wire 72 of the cable 7, thereby satisfying electrical connection regulations and protecting personnel and equipment. In this embodiment, the housing 1 is made of an insulating material, and the grounding element 5 and the housing 1 clamp the grounding wire 72. This clamping manner stably clamps the grounding wire 72 without requiring an additional clamping component, thereby saving cost and avoiding complicated assembly procedures.

One of the grounding element 5 and the second base 24 includes a first protrusion 26, and the other of the grounding element 5 and the second base 24 includes a first slot 51. The first protrusion 26 is insertable into the first slot 51 so that the grounding element 5 and the second base 24 can be quickly assembled with each other, effectively saving assembly time. Similarly, one of the first base 21 and the second base 24 includes a second protrusion 27, and the other of the first base 21 and the second base 24 includes a second slot 23. The second protrusion 27 is insertable into the second slot 23 so that the first base 21 and the second base 24 are assembled with each other.

The second base 24 is interposed between the first base 21 and the grounding element 5. The first base 21, the second base 24 and the grounding element 5 are combined to form one component, which provides a larger contact area with the housing 1 in the internal space 11, so that the first base 21, the combination of the second base 24 and the grounding element 5 is stable, thereby helping maintain assembly stability among the components.

The waterproof assembly 4 further includes an enclosure member 41, a sleeve 42, a waterproof member 43 and a control member 44. The enclosure member 41 is located in the internal space 11 and the cable 7 passes through the enclosure member 41. The sleeve 42 may be made of an elastic material. The sleeve 42 is sleeved on the enclosure member 41 and includes a plurality of claws 421 and a centerline 422. The control member 44 is movably disposed on the housing 1. The control member 44, the housing 1 and the sleeve 42 define a receiving space 45 located on an outer circumferential side of the sleeve 42. The waterproof member 43 is disposed in the receiving space 45. The control member 44 is configured to be operated externally to drive the waterproof member 43 to press against the plurality of claws 421 to contract toward the centerline 422, so that the plurality of claws 421 push against the enclosure member 41 to tighten the cable 7. In this way, there is no gap between the enclosure member 41 and the cable 7, effectively blocking moisture traveling along the cable 7 from the outside.

In this embodiment, the waterproof member 43 is annularly sleeved around the plurality of claws 421. The waterproof member 43 is made of a deformable material, such as but not limited to rubber. The waterproof member 43 is located between the housing 1 and the control member 44. When the control member 44 approaches the housing 1 to clamp the waterproof member 43, the waterproof member 43 deforms under force to push the plurality of claws 421 to move toward the centerline 422.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A waterproof connector including:
a housing including a first opening, an internal space and a second opening in communication with one another, the second opening being configured to allow a cable to pass and extend into the internal space, the cable including at least one conductive wire;
an electrical connection assembly received in the internal space, including a first base, a second base and at least one conductive terminal, the first base being closer to the first opening than the second base, the first base including at least one channel, the second base including at least one positioning portion, the at least one positioning portion being configured to be assembled with the at least one conductive wire, the at least one conductive terminal including a conductive pin portion and a fork portion, the fork portion of the at least one conductive terminal being inserted in the at least one positioning portion and configured to pierce the at least one conductive wire to form an electrical connection, the pin portion of the at least one conductive terminal passing through the at least one channel; and
a waterproof assembly assembled to the housing so that the internal space is blocked from communicating with an outside via the second opening.

2. The waterproof connector of claim 1, wherein the pin portion and the fork portion are integrally formed of one piece.

3. The waterproof connector of claim 1, wherein the fork portion includes a base portion and two piercing members which are spaced apart and protrude from the base portion to pierce the conductive wire, free ends of the two piercing members define a receiving hole which gradually widens in a direction away from the base portion, and the receiving hole is configured to receive a portion of the conductive wire.

4. The waterproof connector of claim 1 further including a conductive grounding element disposed in the internal space and configured to be electrically connected to a grounding wire of the cable.

5. The waterproof connector of claim 4, wherein one of the grounding element and the second base includes a first protrusion, the other of the grounding element and the second base includes a first slot, the first protrusion is insertable into the first slot so that the grounding element and the second base are assembled with each other.

6. The waterproof connector of claim 1 further including a connector, wherein the housing further includes a main body and a pivot portion, the pivot portion protrudes from the main body, the main body and the pivot portion define the internal space, the main body includes the second opening, the pivot portion includes the first opening, and the connector is rotatably sleeved on the pivot portion.

7. The waterproof connector of claim 6, wherein one of the connector and the pivot portion includes an annular groove, the other of the connector and the pivot portion includes a projection, and the projection is movably engaged within the annular groove.

8. The waterproof connector of claim 1, wherein the waterproof assembly further includes an enclosure member, a sleeve, a waterproof member and a control member, the enclosure member is located in the internal space, the cable passes through the enclosure member, the sleeve is sleeved on the enclosure member and includes a plurality of claws and a centerline, the control member is movably disposed on the housing, the control member, the housing and the sleeve define a receiving space located on an outer circumferential side of the sleeve, the waterproof member is disposed in the receiving space, and the control member is configured to be operated externally to drive the waterproof member to press against the plurality of claws to contract toward the centerline so that the plurality of claws push against the enclosure member to tighten the cable.

9. The waterproof connector of claim 8, wherein the waterproof member is made of a deformable material, the waterproof member is located between the housing and the control member, and when the control member approaches the housing to clamp the waterproof member, the waterproof member deforms under force to push the plurality of claws to move toward the centerline.

10. The waterproof connector of claim 2, wherein the fork portion includes a base portion and two piercing members which are spaced apart and protrude from the base portion to pierce the conductive wire, free ends of the two piercing members define a receiving hole which gradually widens in a direction away from the base portion, and the receiving hole is configured to receive a portion of the conductive wire; the waterproof connector further includes a conductive grounding element and a connector, the grounding element is disposed in the internal space and configured to be electrically connected to a grounding wire of the cable; one of the grounding element and the second base includes a first protrusion, the other of the grounding element and the second base includes a first slot, and the first protrusion is insertable into the first slot so that the grounding element and the second base are assembled with each other; the housing further includes a main body and a pivot portion, the pivot portion protrudes from the main body, the main body and the pivot portion define the internal space, the main body includes the second opening, the pivot portion includes the first opening, and the connector is rotatably sleeved on the pivot portion; one of the connector and the pivot portion includes an annular groove, the other of the connector and the pivot portion includes a projection, and the projection is movably engaged within the annular groove; the waterproof assembly further includes an enclosure member, a sleeve, a waterproof member and a control member, the enclosure member is located in the internal space, the cable passes through the enclosure member, the sleeve is sleeved on the enclosure member and includes a plurality of claws and a centerline, the control member is movably disposed on the housing, the control member, the housing and the sleeve define a receiving space located on an outer circumferential side of the sleeve, and the waterproof member is disposed in the receiving space; the control member is configured to be operated externally to drive the waterproof member to press against the plurality of claws to contract toward the centerline so that the plurality of claws push against the enclosure member to tighten the cable; the waterproof member is made of a deformable material, the waterproof member is located between the housing and the control member, and when the control member approaches the housing to clamp the waterproof member, the waterproof member deforms under force to push the plurality of claws to move toward the centerline; one of the first base and the second base includes a second protrusion, the other of the first base and the second base includes a second slot, and the second protrusion is insertable into the second slot so that the first base and the second base are assembled with each other; the second base is interposed between the first base and the grounding element; the housing is made of an insulating material; the grounding element and the housing clamp the grounding wire; the waterproof member is annular and sleeved around the plurality of claws; the first base and the second base are both made of insulating materials; and the sleeve is made of an elastic material.
